(19) United States
(12) Patent Application Publication
(10) Pub. No.: US 2008/0038539 A1
(43) Pub. Date: Feb. 14, 2008

(54) ANTI-IRIDESCENT EASY HANDLING ULTRACLEAR THERMOPLASTIC FILM

(75) Inventors: Nao Yokota, Saunderstown, RI (US); Steven Sargeant, Kingston, RI (US); Arron Carroll, Warwick, RI (US); Hiroshi Furuya, Narragansett, RI (US); Thomas Lemanski, Chepachet, RI (US)

Correspondence Address: MORRISON & FOERSTER LLP, 1650 TYSONS BOULEVARD, SUITE 400, MCLEAN, VA, 22102, US

(73) Assignee: Toray Plastics (America), Inc. Lumirror Divison, N. Kingstown, RI (US)

(21) Appl. No.: 11/835,939

(22) Filed: Aug. 8, 2007

Related U.S. Application Data
(60) Provisional application No. 60/836,428, filed on Aug. 8, 2006.

(51) Int. Cl. B32B 33/00; B29C 47/06; B32B 5/16

(52) U.S. Cl. 428/323; 264/171.1; 264/176.1; 427/322

(57) ABSTRACT

A thermoplastic polyester film including a virtually particle free polyethyleneterephthalate core layer and a skin layer comprising inorganic and organic fillers disposed on the core layer. The inorganic fillers may include aluminum oxide particles, silicon dioxide, zirconium oxide, titanium dioxide, tin oxide, calcium carbonate, barium sulfate, calcium phosphate, zeolite, hydroxy apatite, aluminum silicate and mixtures thereof. The inorganic fillers may have a particle size of from 0.01 μm to 0.60 μm. The organic filler particles may have an average particle size of less than or equal to 1 μm and may be present in an amount of less than 0.1% by weight, based on the weight of the polyethyleneterephthalate. The skin layer may have a thickness of less than 7 μm.

### CROSS-REFERENCE TO RELATED APPLICATIONS

This application claims the benefit of U.S. Provisional Application Ser. No. 60/836,428, filed Aug. 8, 2006.

### FIELD OF INVENTION

The present disclosure is generally related to films and more particularly relates to low haze thermoplastic films with improved handing characteristics.

### BACKGROUND OF INVENTION

Polyethyleneterephthalate films are used for a host of converting, printing, coating and metallizing applications. The thermal stability, dimensional stability, chemical resistance and relative high surface energy of polyethyleneterephthalate films are beneficial for typical end use applications. For instance, polyethyleneterephthalate films are often used as coating bases for magnetic tape, thermal transfer ribbon, packaging materials, thermal lamination and many other web converted products.

Low film haze is often important for a range of applications of polyethyleneterephthalate films, herein sometimes referred to as “polyester films.” Labels, solar control films, and other optical applications often utilize films with very low film haze in order to satisfy end-user expectations. However, many methods of reducing film haze render the polyester films difficult to handle and process. For example, clear polyester films are typically produced by coating or surface treating a plain almost particle free film base. This method produces a clear film, but due to the surface treatment the film's chemical resistance and scratch resistance may be compromised rendering it unsuitable for specific applications.

Furthermore, when a clear polyester film is coated by a clear acrylic coating, for example, a hard coat or a binder, adverse consequences can result. For example, the difference between the refractive index (RI) of an acrylic coating (RI is about 1.5) and a polyester film (for biaxially oriented polyethylene terephthalate, the RI is about 1.66) causes interference between the surface of the acrylic coating layer and the interface between the acrylic coating layer and the polyester film layer, and this interference causes ripples to appear through the spectral reflectance of the acryl coated polyester film. These ripples cause iridescence on the acryl coated polyester film under spectral light of a fluorescent lamp because the light of a fluorescent lamp has a sharp distribution of luminescence to interfere with the ripples of the spectral reflectance of the acryl coated polyester film. If the acryl coated film is hazy, the iridescence does not occur because light is scattered. The opportunity to see iridescence on some applications such as anti-reflective (AR) film and solar control film using acryl coated biaxially oriented film is increasing because of the energy cost savings with fluorescent lamps as compared to incandescent lamps.

Many examples of low haze, easy handling polyester films are known. See, for example, U.S. Pat. Nos. 6,180,209; 5,096,773; 5,023,291; 4,820,583; 5,718,971; 5,475,046; 4,828,918; and 4,092,289; the disclosures of each of which are totally incorporated by reference herein.

U.S. Pat. Nos. 6,706,387 and 6,709,740, the disclosures of each of which are totally incorporated by reference herein, disclose films providing improved clarity and handling. However, these films give an iridescent image when they are coated with acrylic material.

Japanese Patent Application Number 2003-092179 of YOKOTA SUNAO et al. entitled “Transparent Laminated Film for Surface Protection” which is totally incorporated by reference herein, describes in the Abstract thereof a transparent laminated film for surface protection constituted by providing a laminated film (B) with a thickness of 3-20 μm including an acrylic resin on the surface of at least one laminated film (A) of a laminated biaxially stretched polyester film with a thickness of 50-250 μm having the laminated film (A) provided to at least one side thereof, the total light transmissivity of the whole of the transparent laminated film for surface protection is 90% or above and the reflected Y value, reflected x value and reflected y value of the surface of the laminated film (B) of the transparent laminated film for surface protection are present within a range of formula (1).

However, improved materials are desired that meet the requirements of ultra low haze, herein defined for example materials having from about 0.1% to about 1.5% haze or from about 0.1% haze to about 1% haze without observable iridescence after being coated with acrylic material. Such low haze numbers are desired for highest performance in the optical requirements described above. Furthermore, traditional solutions to low haze polyester film formulations render the film handling properties extremely poor, often leading to converter yield losses and a host of other commercial issues. Accordingly, disclosed are ultra low haze polyester film with improved handling characteristics without iridescent after being coated with acrylic material.

### SUMMARY OF THE INVENTION

Embodiments disclosed herein include an ultra low haze thermoplastic polyester film including a skin layer including a blend of polyethyleneterephthalate and inorganic and organic fillers and a virtually particle free polyethyleneterephthalate core layer. These two layers may be co-extruded. The inorganic fillers may include aluminum oxide particles, silicon dioxide, zirconium oxide, titanium dioxide, tin oxide, calcium carbonate, barium sulfate, calcium phosphate, zeolite, hydroxy apatite, or aluminum silicate and mixtures thereof, having a particle size of greater than about 0.01 μm, 0.02 μm or 0.035 μm and a particle size less than about 0.6 μm, 0.4 μm or 0.30 μm. The organic filler particles may have a particle size of less than or equal to about 1 μm or less than or equal to about 0.8 μm and are present in an amount of less than about 0.1%, 0.75% or 0.04% by weight, based on the weight of the polyethyleneterephthalate. The skin layer may have a thickness of less than about 7 μm, 6 μm, or 5 μm. The skin layer may have a thickness of greater than 3 μm. An anti-iridescent coating at a thickness of from about 0.07 μm to about 0.12 μm may be applied to the skin layer to provide a refractive index of from about 1.55 to about 1.62.

The anti-iridescent coating may include a copolyester including naphthalic acid. The anti-iridescent coating may include a blend of polyvinylalcohol-covinylamine grafted with phthalamide at a 5 to 15% mol ratio of polyvinylalcohol-covinylamine to phthalamide.

The organic particles may be prepared from the free radical polymerization of styrene and one or more unsaturated esters. Alternatively, the organic particles may be prepared from the free radical polymerization of styrene, one or more unsaturated esters, and a multifunctional unsaturated crosslinking monomer. The organic particles may also be prepared from a polyesterification reaction between a diacid and diol or a diester and a diol or a combination of a diacid and a diester and a diol.

The amount of inorganic filler may be from 0.4% to 0.8% by weight, based on the weight of the polyethyleneterephthalate. The average particle size of the inorganic filler may be from about 0.05 μm to about 0.2 μm, or about 0.1 μm. The skin layer may have a thickness of between from 0.6 μm to 3 μm. The organic particles may have a particle size of between from 0.5 μm to 0.8 μm.

“Virtually particle free” means that the core layer does not contain particles purposefully placed in the layer. The layer may, however, include particle contaminates.

Embodiments disclosed herein further include a solar control film including an ultra low haze thermoplastic polyester film, a label film including a polystyrene acrylate coating laminated with an ultra low haze thermoplastic polyester film, and an optical film including an acrylate coating laminated with an ultra low haze thermoplastic polyester film.

Further embodiments herein include the preparation of ultra-low haze and easy handling films with an anti-iridescence coating surface. Unwanted iridescent appearance is a common issue with clear films after these films are processed by the end-user. Various surface coatings applied to the surface of ultra-clear films, for example, may cause an oily look to the film due to constructive interference of the different layers. This constructive interference includes not only the surface interference but also interference inside of a construction of an end product. For example, solar control films can include a hard coating layer on the polyester film on the top of the solar film, which can be a source of iridescence.

Solar control films can also include a sputtered polyester film for near infrared ray reflection and an adhesive layer to laminate the hard coated film and the sputtered polyester film. This can be another source of iridescence inside of the construction because the RI of the sputtered layer made from metal or metal oxide such as ITO (Indium-Tin oxide) and the RI of the adhesive layer made by acrylic are different enough from each other and from the RI of polyester film to cause iridescence. An anti-iridescent coating between adhesive layer and the polyester film may eliminate iridescence from the inside when the sputtered polyester film is laminated to the hard coated polyester film.

An embodiment herein relates to a surface coating preparation that may eliminate the constructive interference.

Further embodiments include, for example, a method of making an ultra low haze thermoplastic polyester film by co-extruding a blend of polyethyleneterephthalate with inorganic and organic fillers in at least one skin layer on a virtually particle free polyethyleneterephthalate core layer.

The inorganic fillers may include aluminum oxide particles, silicon dioxide, zirconium oxide, titanium dioxide, tin oxide, calcium carbonate, barium sulfate, calcium phosphate, zeolite, hydroxy apatite, or aluminum silicate and mixtures thereof, having a particle size of greater than about 0.01 μm, 0.02 μm or 0.035 μm and a particle size less than about 0.6 μm 0.4 μm or 0.30 μm. The organic filler particles may have a particle size of less than or equal to about 1 μm or less than or equal to about 0.8 μm and are present in an amount of less than about 0.1%, 0.75% or 0.04% by weight, based on the weight of the polyethyleneterephthalate. The skin layer may have a thickness of less than about 7 μm, 5 μm, or 3 μm. An anti-iridescent coating may be applied to the skin layer with a thickness of from about 0.07 μm to about 0.12 μm and a refractive index of from about 1.55 to about 1.62.

### BRIEF DESCRIPTION OF THE DRAWINGS

FIG. 1 is an illustration of an acryl coated biaxially oriented polyester film in accordance with an embodiment of the present disclosure;

FIG. 2 is a graph illustrating reflectance (y axis) versus wave number (x axis) for acryl coated biaxially oriented polyester film without anti-iridescent coating layer;

FIG. 3 is a graph illustrating reflectance (y axis) versus wave number (x axis) for an acryl coated biaxially oriented polyester film with a desirable anti-iridescent coating layer;

FIG. 4 is a graph illustrating reflectance (y axis) versus wave number (x axis) for an acryl coated biaxially oriented polyester film with anti-iridescent coating layer having a thickness that is less than desirable;

FIG. 5 is a graph illustrating reflectance (y axis) versus wave number (x axis) for an acryl coated biaxially oriented polyester film with an anti-iridescent coating layer having a thickness that is greater than desirable; and

FIG. 6 is a graph illustrating reflectance (y axis) versus wave number (x axis) for an acryl coated biaxially oriented polyester film with having an anti-iridescent coating layer which provides a refractive index that is smaller than desirable.

### DETAILED DESCRIPTION OF THE INVENTION

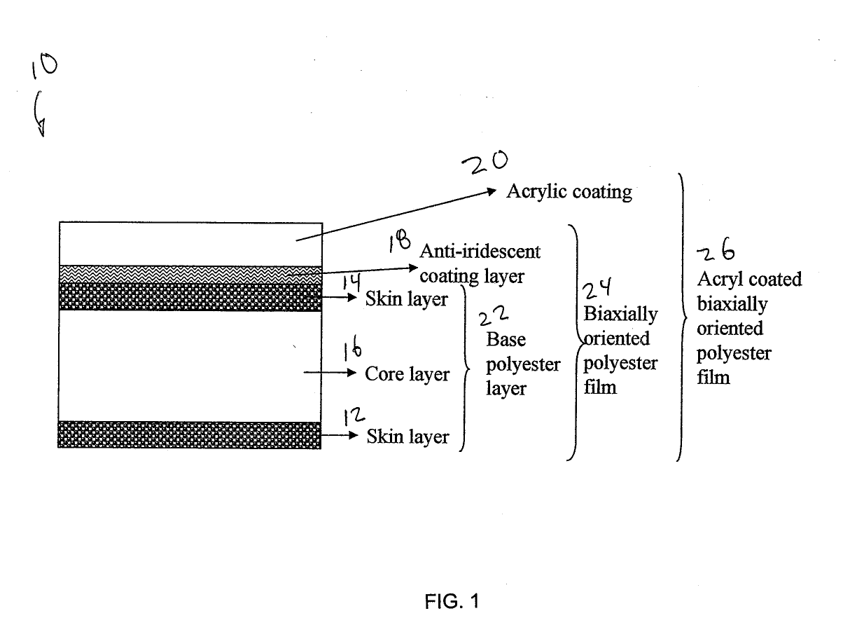

FIG. 1 illustrates an acryl coated biaxially oriented polyester film 10 in accordance with an embodiment of the present disclosure. The film 10 includes skin layers 12 and 14 disposed on opposite sides of a core layer 16. An anti-iridescent coating layer 18 is disposed on skin layer 16, and an acrylic coating 20 is disposed on the anti-iridescent coating layer 18. Together, the core layer 16 and skin layers 12 and 14 form a base polyester layer 22. The base polyester layer 22 is oriented and coated with the anti-iridescent coating layer 18 to provide a biaxially oriented polyester film 24. Film 24 is provided with an acryl coating to provide acryl coated biaxially oriented polyester film 26.

Organic particles can include materials that are roughly spherical in shape. These materials may be prepared by free radical polymerization or polycondensation polymerization to produce stable high polymer. These particles may have high thermal stability, high melting or no melting temperature and good wet-out in a polyester film matrix. Many such methods exist to prepare these organic particles in including, but not limited to, suspension polymerization, dispersion polymerization, emulsion polymerization, melt polymerization and solution polymerization. These particles may be reduced in size through grinding and classification in order to get them in the ranges desired.

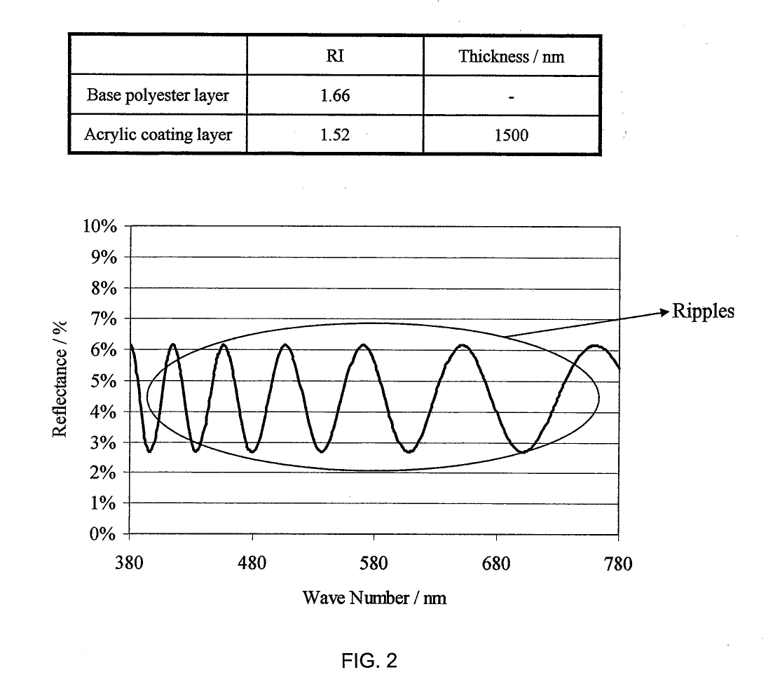

In embodiments, the anti-iridescent layer is laminated at a film thickness of from about 0.07 μm to about 0.12 nm or from about 0.09 μm to about 0.11 μm. When the film thickness is selected at about 0.07 μm to about 0.12 nm, the node of the ripples is located in the center part of visible range (from about 380 to about 780 nm), which can minimize the amplitude of the ripples. If the film thickness is selected to be less than about 0.07 μm, the node shifts to a lower wave number range. If the film thickness is selected to be greater than about 0.12 nm, the node shifts to a higher wave number range. These lower or higher wave ranges may not minimize the amplitude of the ripples. For example, FIG. 2 is a graph illustrating reflectance (y axis) versus wave number (x axis) for acryl coated biaxially oriented polyester film without anti-iridescent coating layer.

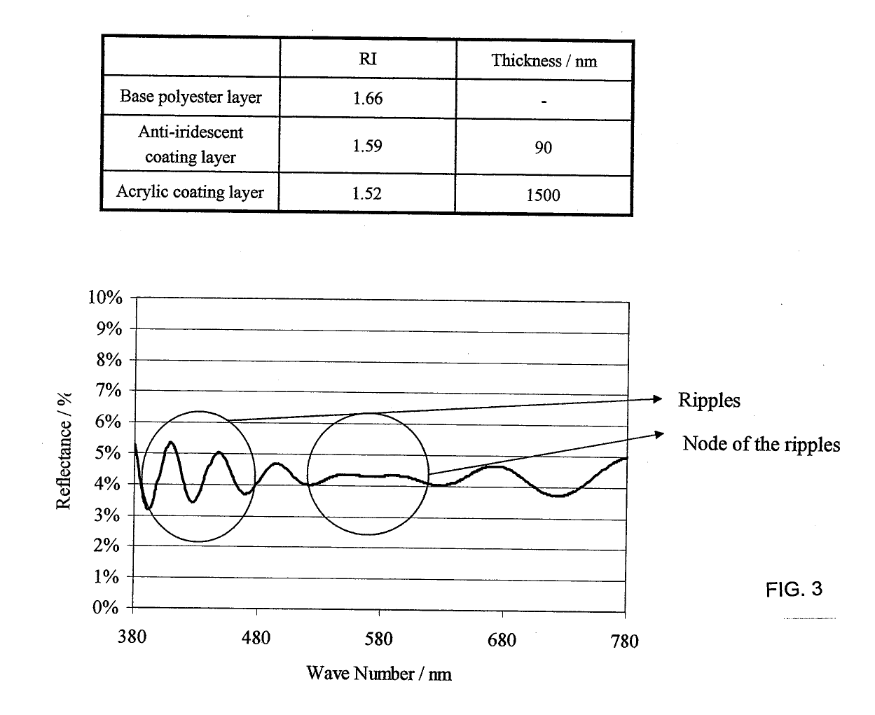

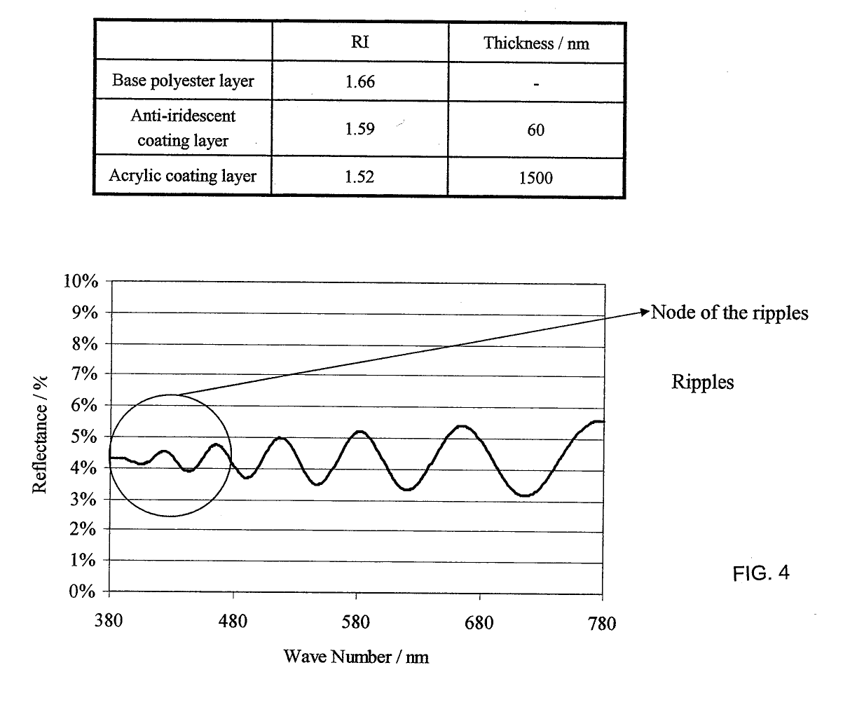

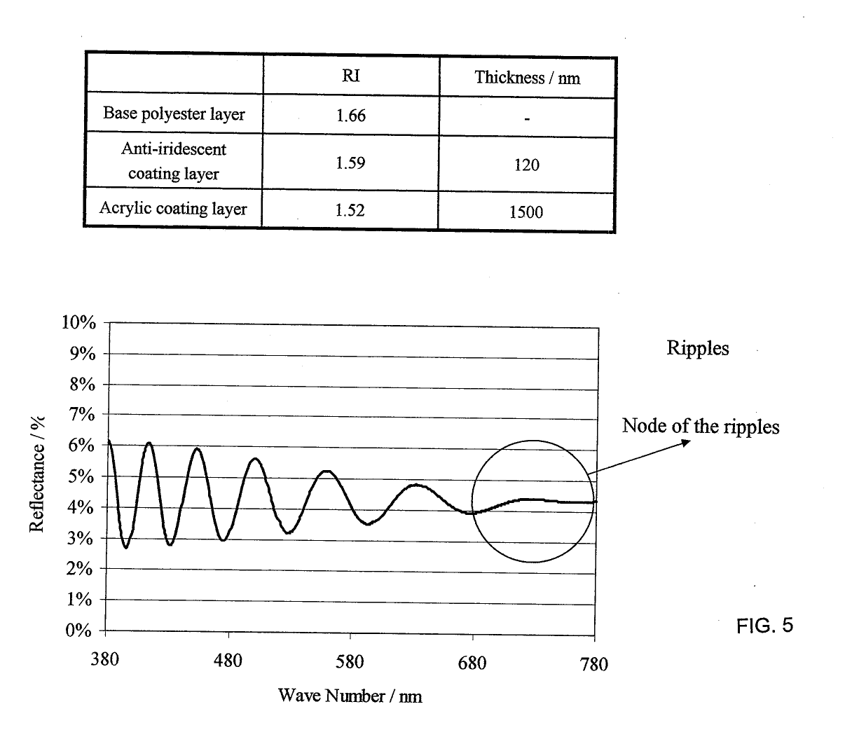

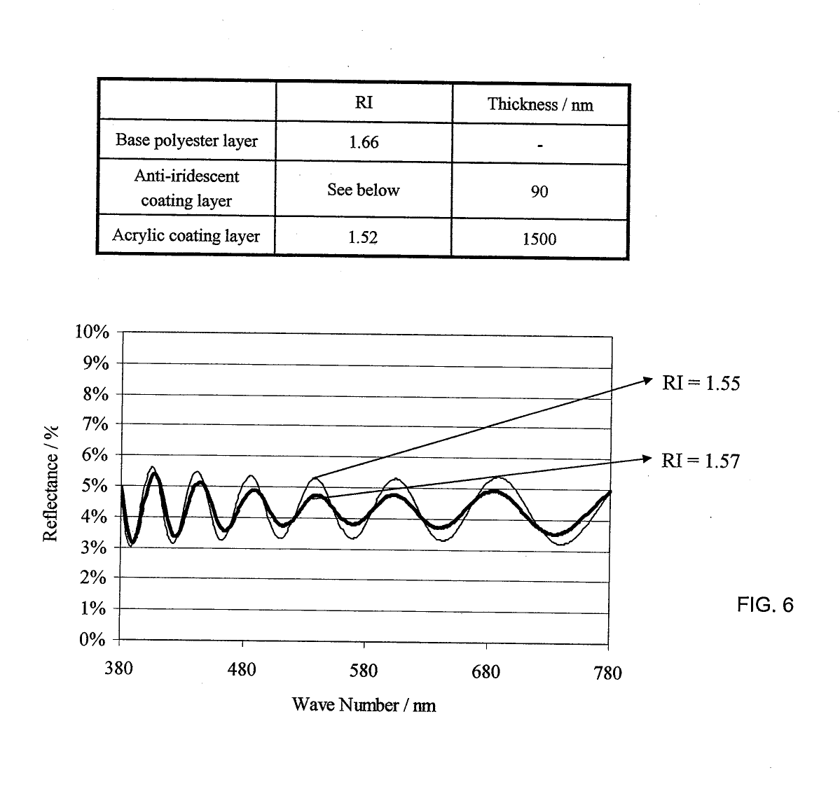

FIG. 3 is a graph illustrating reflectance (y axis) versus wave number (x axis) for an acryl coated biaxially oriented polyester film with a desirable anti-iridescent coating layer. FIG. 4 is a graph illustrating reflectance (y axis) versus wave number (x axis) for an acryl coated biaxially oriented polyester film with anti-iridescent coating layer having a thickness that is less than desirable. FIG. 5 is a graph illustrating reflectance (y axis) versus wave number (x axis) for an acryl coated biaxially oriented polyester film with an anti-iridescent coating layer having a thickness that is greater than desirable. FIG. 6 is a graph illustrating reflectance (y axis) versus wave number (x axis) for an acryl coated biaxially oriented polyester film with having an anti-iridescent coating layer that provides a refractive index that is smaller than desirable.

In embodiments, the anti-iridescent coating materials may be selected from water soluble or dispersible polymers having an RI of from about 1.55 to about 1.62, which represents the mean value of the RI between a biaxially oriented polyester film (having an RI of from about 1.64 to about 1.68) and acrylic materials (having an RI of from about 1.48 to about 1.54). To achieve the desired RI, the coating materials may include aromatic and conjugated components such as styrene, melamine, polyester including a diphenyl or naphthyl structure, imide compounds, and the like, although not limited thereto. If the RI of the coating layer is out of the range of from about 1.55 to about 1.62, the node itself diminishes or disappears and may not be achieved regardless of the thickness of the film. If desired, additives such as cross-linkers, fillers, surfactants, among others, can also be added.

### EXAMPLES

This invention will be better understood with reference to the following examples, which are intended to illustrate specific embodiments within the overall scope of the invention.

Test Methods:

Friction was measured with the use of a Testing Machine, Inc. slip tester (TMI-Model #32-06) using ASTM D1894-95. Polyester film samples were cut to specified sizes. One sheet of polyester was clamped, “A” surface up, onto an 18″ MD (machine direction)×6″ TD (transverse direction) glass plate. Another piece of polyester film was mounted using double-sided tape to a 2.5″×2.5″ 200 g sled, with the “B” surface down. The sled was placed on top of the glass plate and attached to the load sensing device. The sled was then dragged over the film on the glass plate at 6 in/min. The only contact during the testing was polyester film surface “A” rubbing against polyester film surface “B”. The measuring distance used to calculate the value of μs was 1″ and 4″ for μd.

Average surface roughness (Ra) was measured using a Kosaka Laboratory Limited Model #SE-30AK and #Ay-31. The average value of the data of 10 times measurements was taken as the surface roughness of the film according to the present invention. All measurements were run at 50,000× magnification and in the transverse direction of the film. The length of the measurement was 4 mm and the cut-off value was 0.08 mm.

Haze was measured using Suga Test Instruments Co. Model #HGM-2DP, using the methods of ASTM Standard D1003.

Total luminous transmission, herein referred to as TLT, was measured on a Suga Test Instruments Co. Model #HGM-2DP, using method described in ASTM Standard D1003.

Clarity was measured on a Byk Garner Hazeguard-Plus device, using methods described in ASTM Standard D1003.

Cloudiness was assessed by visual inspection as follows: single sheet samples of film were viewed at a distance of approximately 1 ft. in bright sunlight or under intense light at a slight glancing angle, typically less than 15 degrees. Cloudiness is the milkiness or translucence that appears from such a viewer angle. From this assessment a rating system was established for the film samples. A rating value of “poor” (Grade 10) indicates that the sample looks visibly cloudy to the viewer. The samples were then further ranked according to the perceived cloudiness.

Laminate layer and main layer thicknesses were determined based on a ratio of extruder outputs.

Average Particle Size Measurement:

Organic Particles

The particles were placed on the object stage of an electron microscope without overlapping them as far as possible, and observed at a magnification of 10,000 to 100,000 times using a scanning electron microscope or transmission electron microscope. In the case of a scanning electron microscope, on the surface of a sample, a platinum film of about 200 angstroms was vapor deposited using a sputtering apparatus beforehand. From the screen or photographed image, the areas of at least 200 particles were measured to calculate the equivalent diameters, and from the area equivalent diameters the volumes of the individual particles were calculated. Based on the volumes, the volume average particle diameter was calculated. Reference, for example, U.S. Pat. No. 5,912,074, which is totally incorporated by reference herein.

Inorganic Particles

A sample slurry was added to solvent (methanol) at a concentration of the slurry/solvent sufficient to show adequate light transmission. This solution was pipetted into the Honeywell Microtrac X100 machine. The average particle size and distribution was then measured via this machine.

Anti-Iridescent Appearance After Acrylic Coating.

The acryl based hard coat material (UVHC 8558® available from General Electric Corporation) was mixed with an equal amount of methyl ethyl ketone. The mixture was drawn down on the polyester film with a size #3 coating rod and dried in a 175° F. oven for 2 minutes. The film was subsequently cured with UV light of 300WPI for 15 seconds. The back side of the hard coated film was sprayed with flat black paint to eliminate interference from back side. Then, the surface of the hard coating was observed under fluorescent lamp.

Refractive Index and Thickness of the Anti-Iridescent Layer.

The back side surface of the anti-iridescent coated film was sprayed with flat black paint to eliminate the interference from back side. The 5° absolute spectral reflectance (from about 380 to about 780 nm) of the anti-iridescent coated polyester film was measured. Refractive index and thickness were estimated by comparing this measured spectral reflectance and theoretical spectral reflectance which is represented by the following formula

R_{λ}=1−4n₁²nₛ/{n₁²(1+nₛ)²+(1−n₁²)(nₛ²−n₁²)sin²(2πn₁d₁/λ)}

wherein
λ: Wave number/nm
R_{λ}: Reflectance at λ
nₛ: Plane average refractive index of polyester film, (nₓ+n_{y})/2, measured with traditional Abbe's refract meter
n₁: Refractive index of the anti iridescent layer
d₁: Thickness of the anti iridescent layer

### Comparative Example 1

The unagglomerated alumina particles having a -type crystal form and having an average primary particle diameter of 20 nm, a Mohs' hardness of 7.5 are dispersed substantially uniformly in ethylene glycol by a media dispersion method using glass beads having a particle diameter of 50 μm (rotational speed: 3000 rpm, dispersion time: 4 hours), and the ethylene glycol including the alumina particles was polymerized with dimethylterephthalate to make pellets of polyethylene terephthalate. The content of alumina particles in the polyester was 1.5 wt. %. See U.S. Pat. No. 5,284,699, which is totally incorporated by reference herein. During polymerization the alumina particles agglomerated into particles with an average particle size 0.1 μm. The average particle size was found to be approximately 0.1 μm, with a range of about 0.035 μm to about 0.3 μm. This particle type is herein defined as “particle (A)” and this pellet type is herein defined as “pellet (A).”

Polyethyleneterephthalate chips having an intrinsic viscosity of 0.62 were melted using a vent type 2-screw extruder, and a water slurry of the polymer particles prepared above (styrene/bisphenol A diglycidyl ether dimethacrylate copolymer particles) was added, to obtain a polyethylene terephthalate containing organic polymer particles. See U.S. Pat. No. 5,912,074, which is totally incorporated by reference herein. The content of particle (B) in the polyester pellet (B) was 1.0% with an average particle size of 0.8 μm.

Polyethyleneterephthalate chips having an intrinsic viscosity of 0.62 were melted using a vent type 2-screw extruder, and a water slurry of the polymer particles prepared above (styrene/bisphenol A diglycidyl ether dimethacrylate copolymer particles) was added, to obtain a polyethyleneterephthalate containing organic polymer particles. (See U.S. Pat. No. 5,912,074.) The content of particle (C) in the polyester pellet (C) was 1.0% with an average particle size of 0.5 μm.

Next, 49.2 parts by weight of pellets (A), 0.7 parts by weight of pellets (B), 0.9 parts by weight of pellets (C), and 49.2 parts by weight of pellets (D) which did not substantially include any particles, were mixed. The mixed pellets were extruded using a vent-type two-screw extruder and filtered using high accuracy filters. This melt stream (I) was fed through a rectangular joining zone where it was laminated to a melt stream of polyester (II), which contained substantially no particles. The laminate produced a three layer co-extruded I/II/I structure. The resulting melt curtain was quenched on a casting drum, and then biaxially oriented via subsequent stretching steps on a roller train and chain driven transverse stretcher. The biaxially oriented film had a total thickness of 23 μm. Both laminate layers (I) were 1.4 μm in thickness.

The resulting film had an exceptionally low haze value of 0.5% and excellent handling and cloudiness properties as shown in Table 1. However, the iridescence was detected strongly after the acrylic layer was coated.

### Example 1

Film as described in Comparative Example 1 was coated with a surface coating containing co-polyester having naphthalic acid as a component before transverse stretching. The mixtures were applied at a thickness of about 0.1 μm dry thickness after the tentering operation. The film was found to have low haze, excellent handling characteristics and subsequently, was determined to have low irridescence when topcoated with an acrylic based hard coating formulation.

Other surface coatings may also provide the functional benefit of anti-iridescence. It is thought that combination of coating thickness and refractive index are necessary to deliver the desired properties.

### Example 2

An ant iridescent coating consisting of a blend of polyvinylalcohol-co-vinylamine grafted with phthalamide at about a ratio of 5-15% mol ratio of the phthalamide was coated on to the ultra low haze surface. Subsequent processing with an acrylic type hardcoating produced a film with the desired anti-iridescence properties.

| | | Example | | |
|---|---|---|---|---|
| | | Comp. 1 | 1 | 2 |
| Laminate (I) Composition (%) | | | | |
| Particles (A) 0.1 μm Alumina | | 0.74 | | |
| Particles (B) 0.8 μm Organic | | 0.0074 | | |
| Particles (C) 0.5 μm Organic | | 0.0091 | | |
| Particles (E) 0.8 μm CaCO3 | | — | | |
| Particles (F) 0.2 μm SiO2 | | — | | |
| Film Thickness (I/II/I) μm | | 1.4/20.2/1.4 | | |
| Refractive index of the | | n/a | 1.58 | 1.56 |
| anti-iridescent coating layer | | | | |
| Thickness of the | | n/a | 0.1 | 0.1 |
| anti-iridescent coating | | | | |
| layer/μm | | | | |
| Friction | μs | 0.536 | 0.525 | 0.525 |
| | μd | 0.415 | 0.425 | 0.425 |

| | | | |
|---|---|---|---|
| Ra (nm) | 5.0 | 5.0 | 5.0 |
| Haze | 0.5 | 0.6 | 0.6 |
| TLT | 89.1 | 90.5 | 90.5 |
| Clarity | 99.8 | 99.5 | 99.5 |
| Cloudiness | 2 | 2 | 2 |
| Iridescence after acrylic top | Iridescent | Very low | Low iridescent |
| coating | | iridescent | |

Ultra-low haze and easy handling in polyester film are desirable attributes. Such attributes are useful for use in optically clear products such as solar control films, safety films, labels, graphics and other film uses. However, previous solutions to these issues were either deficient in clarity, film handling properties, or more often both.

In our experience, film handling properties are directly related to the friction properties of the film. A high coefficient of friction tends to lead to difficult converting of the film due to difficulties in unwinding the film and in subsequent re-winding of the film due to the possibility of increased static and the requirements for higher load tensions to pull the film through the typical roller train used in converting processes. High coefficients of friction can also lead to end user roll formation issues such as pimples and high edges. For easy converting of the film it is desired to create a static coefficient of friction of less than or equal to about 0.55 together with a dynamic coefficient of friction of less than or equal to about 0.45.

Previous films disclosed, for example, how to manage iridescence, but without providing the characteristic of easy handling. These films required a thickness of greater than from about 50 μm. If the film thickness was selected at less than about 50 μm, the film was too flexible to be easily wound.

The present disclosure provides, in embodiments, films having the desired management of iridescent properties (that is, anti-iridescent) at thickness of less than 50 μm while also providing in combination desired handing characteristics such as ease of winding.

It will be appreciated that various of the above-discussed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

This application discloses several numerical ranges. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A thermoplastic polyester film comprising:
a virtually particle free polyethyleneterephthalate core layer; and
a skin layer comprising inorganic and organic fillers disposed on the core layer;
wherein the inorganic fillers are selected from the group consisting of aluminum oxide particles, silicon dioxide, zirconium oxide, titanium dioxide, tin oxide, calcium carbonate, barium sulfate, calcium phosphate, zeolite, hydroxy apatite, aluminum silicate and mixtures thereof, and wherein the inorganic fillers have a particle size of from 0.01 μm to 0.60 μm;
wherein the organic filler particles have an average particle size of less than or equal to 1 μm and are present in an amount of less than 0.1% by weight, based on the weight of the polyethyleneterephthalate; and
wherein the skin layer has a thickness of less than 7 μm.

2. The film of claim 1, wherein the film further comprises an anti-iridescent coating on the skin layer with a thickness of 0.07 μm to 0.12 μm and a refractive index of from 1.55 to 1.62.

3. The film of claim 2, wherein the anti-iridescent coating comprises copolyester comprising naphthalic acid.

4. The film of claim 2, wherein the anti-iridescent coating comprises a blend of polyvinylalcohol-covinylamine grafted with phthalamide at a 5 to 15% mol ratio of polyvinylalcohol-covinylamine to phthalamide.

5. The film of claim 1, wherein the organic particles are prepared from the free radical polymerization of styrene and one or more unsaturated esters.

6. The film of claim 1, wherein the organic particles are prepared from the free radical polymerization of styrene, one or more unsaturated esters, and a multifunctional unsaturated crosslinking monomer.

7. The film of claim 1, wherein the organic particles are prepared from a polyesterification reaction between a diacid and diol or a diester and a diol or a combination of a diacid and a diester and a diol.

8. The film of claim 1, wherein the amount of inorganic filler is 0.4% to 0.8% by weight, based on the weight of the polyethyleneterephthalate.

9. The film of claim 1, wherein the average particle size of the inorganic filler is from 0.05 μm to 0.2 μm.

10. The film of claim 1, wherein the skin layer has a thickness between from 0.6 μm to 3 μm.

11. The film of claim 1, wherein the organic particles have a particle size between from 0.5 μm to 0.8 μm.

12. The film of claim 1, wherein the core layer and the skin layer are co-extruded.

13. The film of claim 1, wherein the film is a solar control film.

14. The film of claim 1, wherein the film is a label film.

15. The film of claim 1, wherein the film is an optical film.

16. A method of making a thermoplastic polyester film comprising:
co-extruding a virtually particle free polyethyleneterephthalate core layer and a skin layer comprising inorganic and organic fillers disposed on the core layer;
wherein the inorganic fillers are selected from the group consisting of aluminum oxide particles, silicon dioxide, zirconium oxide, titanium dioxide, tin oxide, calcium carbonate, barium sulfate, calcium phosphate, zeolite, hydroxy apatite, aluminum silicate and mixtures thereof, and wherein the inorganic fillers have a particle size of from 0.01 μm to 0.60 μm;
wherein the organic filler particles have an average particle size of less than or equal to 1 μm and are present in an amount of less than 0.1% by weight, based on the weight of the polyethyleneterephthalate; and
wherein the skin layer has a thickness of less than 7 μm.

17. The method of claim 16, further comprising applying an anti-iridescent coating with a thickness of 0.07 μm to 0.12 μm, and a refractive index of from 1.55 to 1.62 to the skin layer.

18. The method of claim 17, wherein the anti-iridescent coating comprises copolyester comprising naphthalic acid.

19. The method of claim 17, wherein the anti-iridescent coating comprises a blend of polyvinylalcohol-covinylamine grafted with phthalamide at a 5 to 15% mol ratio of polyvinylalcohol-covinylamine to phthalamide.

20. The method of claim 16, further comprising preparing the organic particles by a free radical polymerization of styrene and one or more unsaturated esters.

21. The method of claim 16, further comprising preparing the organic particles by a free radical polymerization of styrene, one or more unsaturated esters, and a multifunctional unsaturated crosslinking monomer.

22. The method of claim 16, further comprising preparing the organic particles by a polyesterification reaction between a diacid and diol or a diester and a diol or a combination of a diacid and a diester and a diol.

23. The method of claim 16, wherein the amount of inorganic filler is 0.4% to 0.8% by weight, based on the weight of the polyethyleneterephthalate.

24. The method of claim 16, wherein the average particle size of the inorganic filler is 0.05 μm to 0.2 μm.

25. The method of claim 16, wherein the skin layer has a thickness between from 0.6 μm to 3 μm.

26. The method of claim 16, wherein the organic particles have a particle size between from 0.5 μm to 0.8 μm.

27. The method of claim 16, wherein the core layer and the skin layer are co-extruded.

28. The method of claim 16, wherein the film is a solar control film.

29. The method of claim 16, wherein the film is a label film.

30. The method of claim 16, wherein the film is an optical film.

31. The method of claim 16, further comprising laminating an acrylate coating with the co-extruded core layer and skin layer.

32. A label film comprising:
an acrylate coating laminated with a thermoplastic polyester film comprising a virtually particle free polyethyleneterephthalate core layer and a skin layer comprising inorganic and organic fillers disposed on the core layer;
wherein the inorganic fillers are selected from the group consisting of aluminum oxide particles, silicon dioxide, zirconium oxide, titanium dioxide, tin oxide, calcium carbonate, barium sulfate, calcium phosphate, zeolite, hydroxy apatite, aluminum silicate and mixtures thereof, and wherein the inorganic fillers have a particle size of from 0.01 μm to 0.60 μm;
wherein the organic filler particles have an average particle size of less than or equal to 1 μm and are present in an amount of less than 0.1% by weight, based on the weight of the polyethyleneterephthalate; and
wherein the skin layer has a thickness of less than 7 μm, and has an anti-iridescent coating with a thickness of 0.07 μm to 0.12 μm and a refractive index of from 1.55 to 1.62.
